(19) United States
(12) Patent Application Publication
(10) Pub. No.: US 2015/0308156 A1
(43) Pub. Date: Oct. 29, 2015

(54) CLOSING MECHANISM FOR A MOTOR VEHICLE COMPRISING A CLOSING AID

(71) Applicant: Kiekert AG, Heiligenhaus (DE)

(72) Inventors: Robert J. Hunt, Davisburg, MI (US); Xiang fei Liu, Suzhou City (CN)

(73) Assignee: Kiekert AG, Heiligenhaus (DE)

(21) Appl. No.: 14/263,220

(22) Filed: Apr. 28, 2014

(51) Int. Cl. E05B 47/02

(52) U.S. Cl. CPC E05B 47/023

(57) ABSTRACT

The invention relates to a locking mechanism for a motor vehicle comprising a closing aid. The locking mechanism comprises an electrically driven closing aid which can move a rotary catch of the locking mechanism from a preliminary catching position to a main catching position when the closing aid is in an engaging position. It is possible to move the closing aid from its engaging position to a disengaging position and vice versa. The closing aid cannot move the rotary catch of the locking mechanism from its preliminary catching position to its main catching position when the closing aid is in its disengaging position.

Since it is possible to move the closing aid to a disengaging position, it is possible to open the locking mechanism of the locking mechanism independent from the motor driven closing aid. A malfunction is thereby avoided.

### BACKGROUND OF THE INVENTION

1. Field of the Invention

The invention relates to a locking mechanism for a motor vehicle comprising a closing aid.

2. Description of the Related State of the Art

A locking mechanism for a door or a hatch of a motor vehicle comprises a rotatably mounted rotary catch (also referred to as a rotary latch) for receiving a locking bolt (also referred to as a striker). The locking mechanism moreover comprises a pawl with which the rotary catch can be engaged for retaining the locking bolt.

The rotary catch of a motor vehicle locking mechanism usually comprises a fork-shaped inlet slot (also referred to as inlet opening) which is formed by a load arm and a catching arm and which the locking bolt of a vehicle door or hatch, e.g. a hood or a trunk lid, enters when the door or hatch is closed. The locking bolt or striker then turns the rotary catch from an opened position in the direction of the closed position until the pawl engages the rotary catch. This position is referred to as the catching position. The locking bolt then cannot leave the inlet slot of the rotary catch.

Furthermore, a locking mechanism can comprise a blocking lever capable of blocking the pawl in its catching position. The blocking lever has to be pivoted or turned out of its blocking position in order disengage the locking mechanism. The pawl is able to leave its catching position for opening the locking mechanism, if the blocking lever has been removed from its blocking position.

A locking mechanism is known from US 2010 052 336 A1 in which the rotary catch is capable of introducing an opening moment into the pawl if the latter is in its catching position and engages the rotary catch. Such a locking mechanism requires a blocking lever in order to be able to engage the locking mechanism. The locking mechanism can be opened with little effort.

There are motor vehicle locking mechanisms with two catching positions, i.e. a preliminary catching position and a main catching position. The preliminary catching position serves for rotary catching the respective door or hatch when the latter does not reach the main catching position during the closing process. If, starting from the preliminary catching position, the rotary catch is turned further correspondingly, it will finally reach the main catching position.

A locking mechanism may comprise a motor driven closing aid (also referred to as a closing auxiliary unit) which moves the rotary catch from its preliminary catching position to its main catching position. Such a locking mechanism is known from U.S. Pat. No. 7,059,640 B2, US 2009/0100886 A1 and US 2008/0271503 A1.

As a matter of principle, a locking mechanism comprises a releasing lever which is actuated in order to open or disengage a locking mechanism. Such a releasing lever is typically connected to a handle of a door or hatch. If the handle is actuated, the releasing lever is actuated, or pivoted, in order to disengage the locking mechanism and thus open the lock.

To close a door or a hatch comes with a seal load. To move the locking mechanism from its preliminary catching position to its main locking position increases the seal load.

### SUMMERY OF THE INVENTION

It is an object of the invention to provide a locking mechanism for a motor vehicle comprising a locking mechanism and a motor driven closing aid.

Another object of the invention is to provide a locking mechanism for a motor vehicle having a reduced number of components.

Another object of the invention is to provide a locking mechanism for a motor vehicle having a reduced package size and/or a reduced overall mass.

Another object of the invention is to provide a locking mechanism allowing to open the locking mechanism independent from the electrically driven closing aid.

Another object of the invention is to avoid a malfunction of a locking mechanism which comprises an electrically driven closing aid.

Another object of the invention is to provide a locking mechanism comprising an electrically driven closing aid which trade travel for force in parallel with the rise in a striker seal load.

In order to solve at least one of the objects of the invention, a locking mechanism for a motor vehicle comprises an electrically driven closing aid which can move a rotary catch of the locking mechanism from a preliminary catching position to a main catching position when the closing aid is in an engaging position. It is possible to move the closing aid from its engaging position to a disengaging position and vice versa. The closing aid cannot move the rotary catch of the locking mechanism from its preliminary catching position to its main catching position when the closing aid is in its disengaging position.

Since it is possible to move the closing aid to a disengaging position, it is possible to open the locking mechanism of the locking mechanism independent from the motor driven closing aid. A malfunction is thereby avoided.

The invention further refers to a locking mechanism for a motor vehicle comprising an electrically driven closing aid wherein the closing aid comprises a rotatably mounted closing aid lever and a salient which can catch and move a salient of the rotary catch by rotary movement in order to move the rotary catch from a preliminary catching position to a main catching position.

In this way, there is an interface between the rotary catch and the closing aid which is designed to trade travel for force in parallel with the rise in striker seal load. Further, the locking mechanism comprises a reduced number of parts.

In an embodiment of the invention, it is possible to turn the axis 10 around the shaft 11 manually.

### BRIEF DESCRIPTION OF THE DRAWINGS

Additional measures and advantages of the invention can be derived from the sub-claims, from the following description and/or from the drawings which illustrate an exemplary embodiment of the invention.

FIG. 1 is a perspective view of a locking mechanism in its main locking position in accordance with an exemplary embodiment of the invention;

FIG. 2 is a top view of the locking mechanism in its opened position in accordance with the exemplary embodiment of the invention;

FIG. 3 is a top view of the locking mechanism in its preliminary catching position in accordance with the exemplary embodiment of the invention;

FIG. 4 is a top view of the locking mechanism in an overtravel position in accordance with the exemplary embodiment of the invention;

FIG. 5 is a top view of the locking mechanism in the disengaging position of the closing aid.

### DETAILED DESCRIPTION OF THE INVENTION

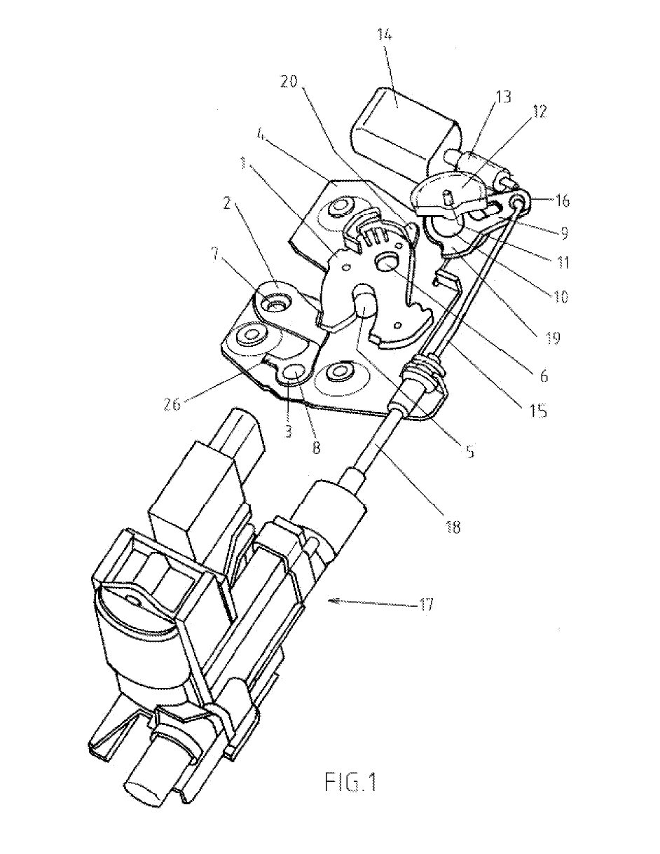

As shown in FIG. 1, the locking mechanism comprises a rotary catch 1, a pawl 2 and a blocking lever 3. Rotary catch 1, pawl 2 and blocking lever 3 are rotatably mounted on a metal plate 4. The rotary catch 1 can rotate around its axis 6. The pawl 2 can rotate around its axis 7. The blocking lever 3 can rotate around its axis 8. The rotary catch 1 comprises a fork-shaped inlet slot 5 which a locking bolt (not shown) enters when the corresponding door or hatch is closed. The locking bolt then turns the rotary catch 1 from an opened position in the direction of the closed position until the pawl 2 engages the rotary catch 1. FIG. 1 shows the locking mechanism in its main catching position.

In the main catching position respectively main locking position as shown in FIG. 1, the rotary catch 1 introduces an opening moment into the pawl 2. Since the pawl 2 is blocked by the blocking lever 3, the pawl 2 rests in its catching position. Thus, the blocking lever 3 has to be pivoted out of its blocking position in order disengage the locking mechanism.

A closing aid of the locking mechanism comprises a closing aid lever 9 which can rotate around its axis 10. The axis 10 of the closing aid lever 9 is rotatably mounted and can rotate around the shaft 11. The shaft 11 is situated beside the center of the axis 10. In other words, there is a distance respectively clearance between the center of the axis 10 and the shaft 11. For this reason, rotation of the axis 10 around its shaft 11 comes with a displacement of the axis 10. The axis 10 is displaceable in order to move the closing aid lever 9 from an engaging position to a disengaging position and vice versa.

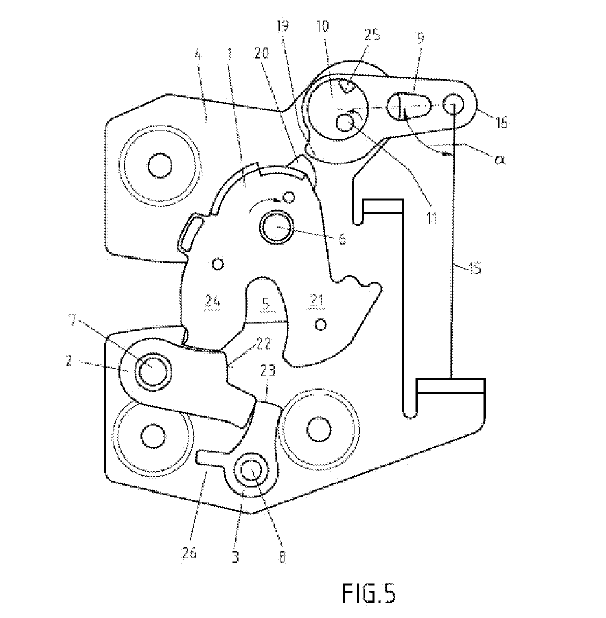

In the engaging position, the closing aid lever 9 can move the rotary latch 1 to its main catching position. In the disengaging position, the closing aid lever 9 cannot move the rotary latch 1 to its main catching position. In the FIGS. 1 to 4, the closing aid lever 9 is in an engaging position. FIG. 5 shows the closing aid lever 9 in a disengaging position.

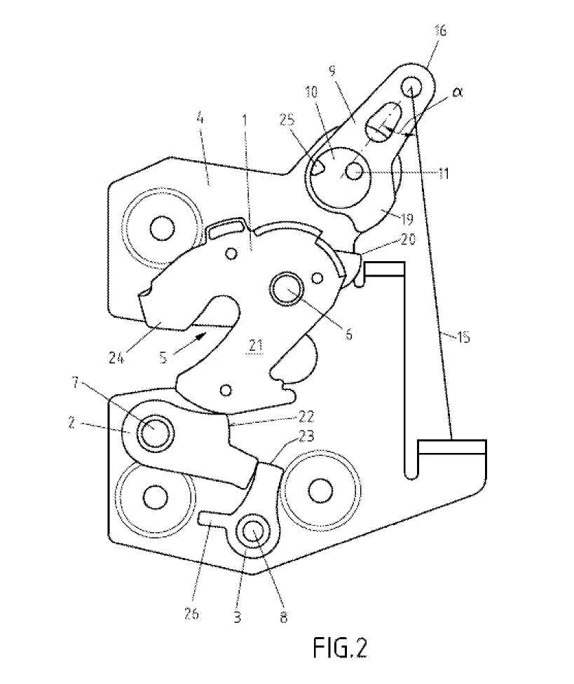

A cog wheel 12 is attached to the shaft 11 (not shown in the FIGS. 2-5). A worm gear 13 of a motor 14 engages the cog wheel and can rotate the cog wheel and can thus rotate the shaft 11 in order to displace the axis 10. One end of an inner cable 15 of a Bowden cable is connected to an end of an arm 16 of the closing aid lever 9. The further end of the inner cable 15 of the Bowden cable is connected to an electric drive 17. One end of the hollow outer cable 18 of the Bowden cable is fastened at the metal plate 4 in an appropriate manner so that it is possible to transmit mechanical force by the movement of the inner cable relative to the hollow outer cable housing. The electric drive 17 can move the inner cable 15 in order to rotate the closing aid lever 9 in a clockwise manner. In this way, a salient 19 of the closing aid lever 9 can catch a salient 20 of the rotary catch 1 in order to move the rotary catch 1 in its main catching position when the closing aid lever 9 is in its engaging position.

The Bowden cable can be replaced by a rod which is connected with the arm 16 as well as with the electrical drive 17.

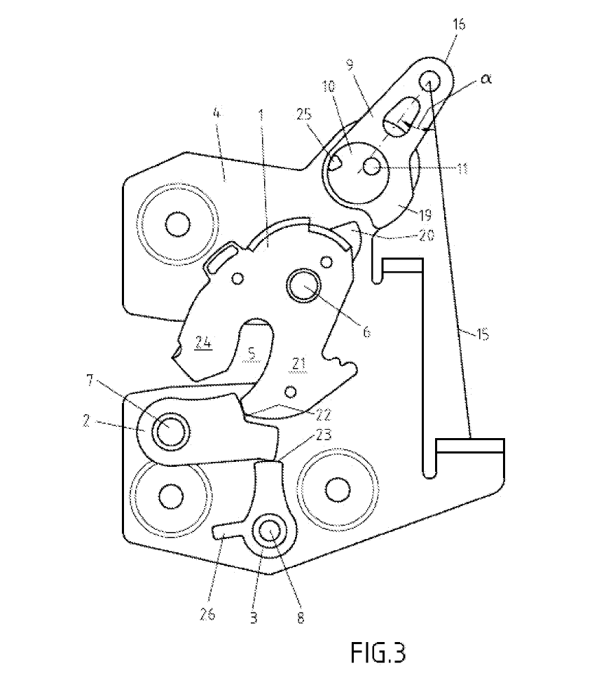

FIG. 2 shows in part the locking mechanism of FIG. 1 in its opened position. A striker of a door or a hatch can enter the inlet slot 5 of the rotary catch 1 in order to rotate the rotary catch 1 in a counter clockwise manner around its axis 6 towards its preliminary catching position as shown in FIG. 3. The pawl 2 rests against an end portion of the catching arm 21 of the rotary catch 1 for example due to a pre-stressed spring (not shown). The blocking lever 3 rests against an end portion of the pawl 2 for example due to a pre-stressed spring (not shown). The closing aid lever 9 and the inner cable 15 of the Bowden cable form an acute angle α with a measure between 30° and 60°, preferably between 40° and 50°.

FIG. 3 shows the locking mechanism of FIG. 1 in its preliminary catching position. The catching arm 21 of the rotary catch 1 rests against the sloped stopping surface 22 of the pawl 2 for example due to a pre-stressed spring (not shown) and/or due to a seal load. As a result, the rotary catch cannot rotate in its opened position in a clockwise manner around its axis 6. The pawl 2 rests against the stopping surface 23 of the blocking lever in such a manner that the pawl 2 cannot leave its catching position. The stopping surface 22 of the pawl 2 is slopped in such a manner that the rotary catch 1 introduces an opening moment into the pawl 2 in its catching position. In FIG. 3, the closing aid lever 9 is in its engaging position since the salient 19 of the closing aid lever 9 can catch the salient 20 of the rotary catch 1. The preliminary catching position comes with an increased acute angle α in comparison with the opened position. The acute angle α is less than 90°.

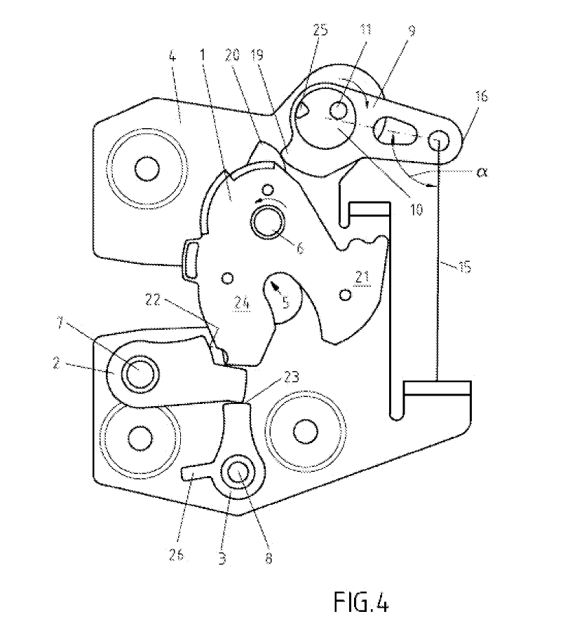

When for example a sensor like a position switch (not shown) detects that the locking mechanism is in its preliminary catching position, the sensor signals to activate the electric drive 17. As a result, the closing aid lever 9 rotates in a clockwise manner around its axis 10. Then, the salient 19 of the closing aid lever 9 catches the salient 20 of the rotary catch 1 and moves the salient 20 in such a manner that the rotary catch 1 rotates in a counter clockwise manner until the locking mechanism arrives at the position shown in FIG. 4. The salient 20 and the salient 19 form an interface between the closing aid lever 9 and the rotary catch 1. The geometry of the interface between the closing aid lever 9 and the rotary catch 1 is in this way designed to trade travel for force in parallel with the rise in striker seal load.

When the rotary catch 1 reaches the preliminary catching position, a sensor like a position switch notifies the reached position and controls the further operation: The blocking lever 3 leaves its blocking position and load arm of the rotary catch 1 over travels the pawl 2. The geometry reaches a by pass state so that the system is not overly stressed.

As shown in FIG. 4, the rotary catch 1 arrived at an overtravel position. This means that the rotary 1 has to rotate back in a clockwise manner until the load arm 24 of the rotary catch 1 rests against the stopping surface 22 of the pawl 2 in order to arrive at its main locking position. The pawl 2 cannot leave its catching position since the pawl 2 rests against the stopping surface 23 of the blocking lever 3. Preferably, such an overtravel position is possible in order to be sure that the locking mechanism can always arrive at its main catching position.

Starting from the opened position, the acute angle α increases as explained. As soon as the locking mechanism arrives at its main catching position, the angle α is preferably approximately 90°.

A seal load (resulting from a compressed seal of the corresponding door or hatch) is higher in the main catching position than in the preliminary catching position of the locking mechanism. For this reason, the angle α is at the beginning as shown in FIG. 2 an acute angle which may increase up to 90° and is in the overtravel position preferably about 90° or a little bit more than 90° as shown in FIG. 4. The increase of the angle comes with a favorable lever ratio in order to overcome the rise in striker seal load since the distance between the center of the axis 10 and the end portion of the salient 19 is small compared with the distance between the center of the axis 10 and the fastening position of the inner cable 15 at the arm 16.

The axis 10 comprises preferably a nose 25 away from its center. The nose 25 extends into a recess of the cog wheel. As a result, there is interlocking connection respectively positive fit connection between the cog wheel and the axis 10 in order to avoid a malfunction.

However, when a releasing lever is actuated in order to open or to disengage the locking mechanism during the clinching, a sensor detecting the actuation signals activates the electrical motor 14. As a consequence, the axis 10 rotates around the shaft 11 and moves the closing aid lever 9 from its engaging position to its disengaged position. In other words, the closing aid lever may rotate when the release chain is operated in order to bring the closing aid in the disengaging position. This operation can be controlled by one or more sensors (not shown). For this reason, it is always possible to open the locking mechanism independent from the further motion of closing aid and the position of the rotary catch 1.

FIG. 5 shows the disengaging position of the closing aid lever 9. Due to the displacement of the closing aid lever 9, the salient 19 of the closing aid lever 9 cannot catch the salient 20 of the rotary catch 1. For this reason, it is possible to activate a releasing lever independent from the motion of the closing aid. As soon as the blocking lever 3 is removed from its blocking position, the pawl 2 leaves its catching position as shown in FIG. 5. Then, the rotary catch 1 can rotate in a clockwise manner in order to arrive at the position as shown in FIG. 2 as soon as the closing aid arrived at its disengaging position and/or as soon the closing aid lever 9 is in the position shown in FIG. 2.

The locking mechanism comprises a releasing lever (not shown) which is actuated in order to open or disengage a locking mechanism. The releasing lever is connected to a handle of a door or hatch and/or to an electrical drive (not shown). If the handle respectively the electrical drive is actuated, the releasing lever is actuated, or pivoted, in order to catch and rotate the arm 26 of the blocking lever 3 for removing the blocking lever 3 from its blocking position.

What is claimed:

1. A locking mechanism for a motor vehicle comprising an electrically driven closing aid wherein the closing aid can be moved from an engaging position to a disengaging position and vice versa and wherein the closing aid can move a rotary catch of the locking mechanism from a preliminary catching position to a main catching position if the closing aid is in its engaging position but cannot move the rotary catch of the locking mechanism from its preliminary catching position to its main catching position if the closing aid is in its disengaging position.

2. A locking mechanism according to the preceding claim wherein the axis of the closing arm is eccentric to a root component of the release chain whereby the closing arm is always pulled away from the catch.

3. A locking mechanism according to the preceding claim wherein the closing aid comprises a rotatably mounted closing aid lever which can rotate around a displaceable mounted axis.

4. A locking mechanism according to the preceding claim wherein the axis can be displaced by a turning the axis around a shaft.

5. A locking mechanism according to the preceding claim wherein an electrically drive cog wheel is attached to the shaft for displacing the axis.

6. A locking mechanism according to the preceding claim wherein a nose and a recess provides a positive-fit connection between the cog wheel and the shaft.

7. A locking mechanism according to claim 1 comprising one or more sensors controlling the movement of the closing aid.

8. A locking mechanism according to claim 1 wherein the closing aid comprises a rotatably mounted closing aid lever and a salient which can catch and move a salient of the rotary catch by a rotary movement in order to move the rotary catch from a preliminary catching position to a main catching position.

9. A locking mechanism according to the preceding claim wherein a Bowden cable or a rod is attached to an arm of the closing aid lever and wherein the Bowden cable or the rod is further attached to an electrical drive.

10. A locking mechanism according to claim 1 comprising a pawl for engaging the rotary catch in its preliminary catching position and in its main catching position.

11. A locking mechanism for a motor vehicle comprising an electrical driven closing aid for moving a rotary catch of the locking mechanism from a preliminary catching position to a main catching position wherein the closing aid comprises a rotatably mounted closing aid lever and a salient which can catch and move a salient of the rotary catch by a rotary movement in order to move the rotary catch from a preliminary catching position to a main catching position.

12. A locking mechanism according to claim 1 wherein the catching arm of the rotary catch rests against a stopping surface of a pawl when the locking mechanism is in its preliminary catching position.

13. A locking mechanism according to the preceding claim wherein the load arm of the rotary catch rests against a stopping surface of the pawl when the locking mechanism is in its main catching position.

14. A locking mechanism according to the preceding claim wherein a Bowden cable or a rod is attached to an arm of the closing aid lever and wherein the Bowden cable or the rod is further attached to an electrical drive.
